(19) United States
(12) Patent Application Publication
(10) Pub. No.: US 2010/0176922 A1
(43) Pub. Date: Jul. 15, 2010

(54) MOBILE RADIO FREQUENCY IDENTIFICATION (RFID) READER SYSTEM

(76) Inventors: Paul John Schwab, Nashua, NH (US); Matthew Lannon, Dracut, MA (US); Robert Schilling, Londonderry, NH (US)

Correspondence Address: Vern Maine & Associates, 547 AMHERST STREET, 3RD FLOOR, NASHUA, NH, 03063-4000, US

(21) Appl. No.: 12/352,258

(22) Filed: Jan. 12, 2009

(51) Int. Cl. H04Q 5/22

(52) U.S. Cl. 340/10.1

(57) ABSTRACT

A mobile radio frequency identification (RFID) reader system is provided. The RFID reader system includes an RFID reader. The RFID reader system further includes a primary antenna for transmitting RFID signals to acquire RFID information from RFID item tags and a secondary antenna for transmitting RFID signals to acquire RFID information from one of RFID shelf tags and RFID floor tags.

### BACKGROUND OF THE INVENTION

This invention relates generally to radio frequency identification (RFID) systems, and more particularly to RFID readers for RFID systems.

RFID systems are increasingly used to acquire information that may be used, for example, to monitor and track products and processes or to track and locate inventory, such as within a warehouse. For example, RFID systems may be used to monitor the inventory of products, such as the quantity and location of pallets on multilevel shelves.

Conventional mobile RFID readers include a reader engine and a single RFID reader antenna. The mobile RFID reader is then moved, for example, around a warehouse on a forklift to track pallets that are being stored on or removed from different rows of shelves in a multilevel shelving system by the forklift. Each shelf of a vertical shelving unit also includes a unique identifier that may be determined from a passive RFID tag on the front of each shelf. However, because of the close proximity of the shelves, the RFID reader often reads multiple shelf tags when approaching or backing away from shelves, such as when loading or unloading a pallet using a forklift. As a result, determining the location of a pallet is often very difficult. Also, tracking the amount of current inventory based on the pallets is difficult because multiple pallets may be read at the same time. Conventional RFID reader systems also may detect and read shelf tags while on a forklift passing through aisles of shelves, thereby farther compounding the issue of determining the location of and amount of current inventory.

RFID tags on different sized pallets also may need to be read. However, many conventional reader systems assume a fail height pallet such that, for example, RFID tags on half height pallets may not be read. Moreover, in conventional reader systems used with forklifts, the reader system cannot determine when a pallet is picked up or placed on a shelf, thereby requiring operator intervention. Thus, conventional readers when used, particularly in warehouse applications, have problems with read rates and accuracy. In many instances theses conventional systems are not accurate enough to achieve an adequate level of inventory control including the tracking of inventory, location of inventory, amount of inventory, etc.

### BRIEF DESCRIPTION OF THE INVENTION

In accordance with one embodiment, a radio frequency identification (RFID) reader system is provided that includes an RFID reader. The RFID reader system further includes a primary antenna for transmitting RFID signals to acquire RFID information from RFID item tags and a secondary antenna for transmitting RFID signals to acquire RFID information from one of RFID shelf tags and RFID floor tags.

In accordance with another embodiment, a forklift is provided that includes a movable portion having at least one fork and a radio frequency identification (RFID) reader. The forklift further includes a primary antenna mounted to the movable portion and a secondary antenna mounted to the movable portion. The primary and secondary antennas transmit RFID signals for reading RFID tags by the RFID reader.

In accordance with yet another embodiment, a method for tracking inventory is provided. The method includes transmitting an RFID signal from a first antenna mounted to a forklift and transmitting an RFID signal from a second antenna mounted to a forklift. The method farther includes validating RFID information received in response to at least one of the RFID signals transmitted from the first antenna and the second antenna. The RFID information is validated using information from a plurality of different sensor types.

### BRIEF DESCRIPTION OF THE DRAWINGS

FIG. 1 is a block diagram of mobile RFID reader system constructed in accordance with various embodiments of the invention.

FIG. 2 is a front perspective view of a forklift including a mobile RFID reader system constructed in accordance with an embodiment of the invention.

FIG. 3 is a front perspective view of a forklift with the forks removed and including a mobile RFID reader system constructed in accordance with an embodiment of the invention.

FIG. 4 is a perspective view of a primary antenna and reader module of the mobile RFID reader system of FIG. 1.

FIG. 5 is a top plan view of an antenna of the mobile RFID reader system of FIG. 1.

FIG. 6 is a top plan view of a metal cover for the antenna of FIG. 5.

FIG. 7 is a front perspective view of a shelf unit in connection with which the mobile RFID reader system of FIG. 1 or the forklift of FIGS. 2 and 3 may be used to read RFID tags associated therewith.

FIG. 8 is side elevation view of a forklift illustrating different signals transmitted from a mobile RFID reader system constructed in accordance with various embodiments of the invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments of the invention provide a reader system for a radio frequency identification (RFID) system. The reader system is a mobile system and generally includes two different antennas: (i) one RFID antenna for reading RFID tags associated with items, which may include, for example, individual items or a group/collection of items, such as a pallet and (ii) one RFID antenna for reading RFID tags associated with the location, for example, shelves or floor locations on which and off of which the pallets are being moved. The RFID reader system also includes other sensors to provide improved location determination when reading the RFID tags and to verify or validate RFID information acquired by the reader system.

It should be noted that although the various embodiments of an RFID reader system may be described in connection with a particular application, for example, a forklift application in a warehouse, the various embodiments are not limited to such an application. The various embodiments of an RFID reader system may be implemented or used in connection with any RFID system in which RFID tags are to be read by a movable or mobile/portable RFID reader, for example, on a movable or motorized hand truck, a moving pallet loader, etc.

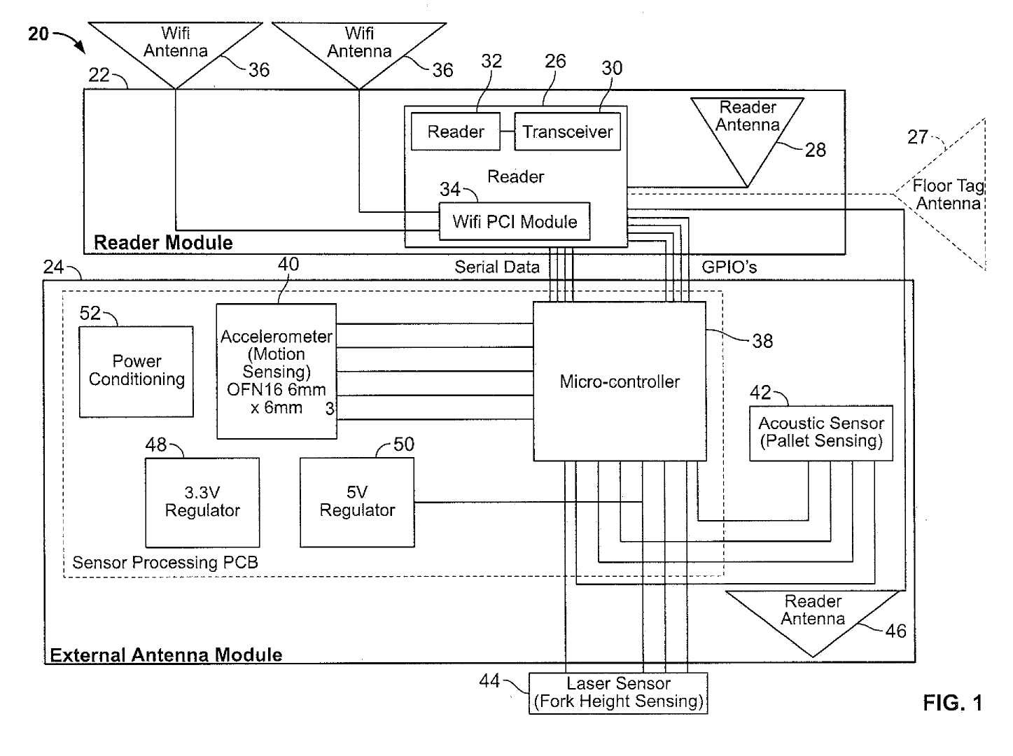

Specifically, as shown in FIG. 1, an RFID reader system 20, which in one embodiment is a mobile system, includes a reader module 22 and an external antenna module 24. It should be noted that the modules 22 and 24 are not necessarily indicative of a hardware or software division of the components of the RFID system 20. The reader module 22 includes an RFID reader 26, which may be any type of RFID reader as is known that is capable of reading RFID tags, such as passive RFID tags or active RFID tags.

The RFID reader 26 may be, for example, of the type configured to read passive RFID tags or passive radio reflective identification tags. The passive RFID tags do not include a battery or other power source and when radio waves from the RFID reader 26, which may be configured as an RFID interrogator, are detected by an antenna of the passive RFID tag, the energy is converted by the antenna into electricity that can power up, for example, a processor, such as a microchip in the passive RFID tag. The passive RFID tag is then able to communicate, and more particularly, transmit to the RFID reader 26 information stored in the microchip. For example, the information transmitted may include the type of object or pallet to which the passive RFID tag is connected, including, for example, a serial number, the time and date of the transmission, etc. and which is generally referred to herein as RFID tag information. In a warehouse application, the RFID tag information also may include the shelf, including a shelf unit number and level on which or from which a pallet is being moved.

It should be noted that the RFID reader 26 is not limited to reading passive RFID tags, but may instead or in addition to reading passive RFID tags, read active radio identification tags or active RFID tags. The active RFID tags also include a transmitter to communicate, and more particularly, transmit (as opposed to reflecting back) signals to the RFID reader 26 including the RFID tag information. The active RFID tags use a battery or other power source (e.g., optically powered) to transmit the signals to the RFID reader 26.

Referring again to FIG. 1, the reader module 22 includes a first antenna, which in the various embodiments is a primary antenna 28, and is configured as an RFID reader antenna, connected to the RFID reader 26. The primary antenna 28 is configured to transmit radio-frequency (RF) signals generated by the reader module 26. In a warehouse application, the primary antenna 28 is configured to generate RF signals to activate RFID tags associated with pallets being placed on or removed from shelves within the warehouse (or to read RFID tags associated with pallets already placed on shelves). RFID tag information from the activated RFID tags is then received by the primary antenna 28 and processed by the reader module 26 as is known. It should be noted that the antenna pattern generated by the primary antenna 28 is a broader pattern that is, for example, polarization diverse and having a broader beam pattern in the horizontal direction to encompass broader areas, such as a multiple pallets or an entire shelf or area. The antenna pattern of the primary antenna 28 may be generated in any known manner to activate RFID tags in such a coverage area. Also, the antenna pattern of the primary antenna 28 may be steerable as is known. The acquisition of RFID tag information from pallets is discussed in more detail below.

The RFID reader 26 also may include a transceiver 30 and decoder 32 as is known. The transceiver 30 and decoder 32 may be provided as a single unit, separate units or part of the RFID reader 26 (as shown in FIG. 1). Additionally, in an alternate embodiment, the transceiver 30 is replaced by a separate transmitter (not shown) and receiver (not shown). In operation, the primary antenna 28 may be configured as a scanning antenna that transmits RF signals, for example, RFID signals. The transceiver 30 may be configured such that the RF signals are transmitted over a determined range, for example, 5 or 10 feet and over a broader coverage angle, for example, thirty degrees to read information from RFID tags from multiple pallets on a shelf The RF signals, which are essentially RF radiation, allow communication with the RFID tags as is known. For example, the RF signals allow communication with a microchip of the RFID tags. The RF radiation may provide energy to energize passive RFID tags as is known, such that the passive RFID tags are activated to communicate with the RFID reader 26.

When RFID tags, for example, on or in a pallet, pass through an RF radiation field generated by the RF reader 26 and transmitted by the primary antenna 28, the RFID tag detects the signal (e.g., activation signal) from the RFID reader 26. The RFID tag is activated, which may include energizing the RFID tag and RFID tag information, for example, stored on the microchip in the RFID tag is transmitted back to the RFID reader 26. For example, the RFID tag information may be reflected back by the RFID tag or may be transmitted back using an RFID tag transmitter of the RFID tag.

Upon receiving the signals from the RFID tags via the primary antenna 28 and using the transceiver 30, and that includes the RFID tag information, the signals are decoded in any known manner, for example, using the decoder 32. It should be noted that RFID tag information from a plurality of RFID tags may be transmitted at the same time.

The RFID reader 26 also includes or is connected to a communications interface 34, illustrated in FIG. 1 as a WiFi PCI module. The communications interface is 34 connected to one or more communication antennas 36. The communications interface 34 and one or more communication antennas 36 provide communication to a wireless network or remote system, for example, to communicate with a remote server, computer or controller of a wireless communication system or an enterprise system. Communications may be provided using any known communication standard. For example, in one embodiment, the communications interface 34 is configured to communicate using the one or more antennas 36 configured to operate in an IEEE 802.11 communications standard. Moreover, the communications interface 34 is not limited to communicating using WiFi standards, but may be configured to provide communication using different communication standards and protocols.

Referring now to the external antenna module 24, the reader module 22 and the external antenna module are communicatively coupled, for example, using a wired or wireless connection. In one embodiment, a processor 38 of the external antenna module 24 is connected to the RFID reader 26 of the reader module 22. However, the reader module 22 and external antenna module 24 may be communicatively coupled using other components as desired or required, for example, based on system requirements.

The processor 38 is connected to one or more sensors. For example, in one embodiment the processor 38 is connected to a motion sensor 40, such as an accelerometer. The processor 38 also may be connected to an pallet sensor 42, for example, an acoustic pallet sensor and a height sensor 44, for example, a laser height sensor. The sensors 40, 42, 44 are configured generally to sense or detect motion of a movable object (e.g., a forklift) or a component thereof and to which the RFID reader 26 is attached. It should be noted that the various embodiments of the invention are not limited to the sensors 40, 42, 44 and additional sensors may be provided in addition to or instead of the sensors 40, 42, 44. Moreover, the sensors 40, 42, 44 need not be sensors that detect or sense motion or distance traveled. For example, additional or different sensors may include a moisture sensor, a temperature sensor, a location sensor (e.g., a CPS device), a noise sensor (e.g., dB sensor), etc. Also, the sensors 40, 42, 44 may be located in different positions or in different orientations with respect to the RFID reader system 20. For example, in a warehouse application, the sensors 40, 42, 44 may be positioned or mounted at different locations on a forklift as described in more detail below to sense different movements of the forklift or components or operations thereof.

The RFID reader 26 of the reader module 22 is also connected to a second antenna, which in the various embodiments is a secondary antenna 46, and is configured as another reader antenna. The secondary antenna 46 is configured to transmit radio-frequency (RF) signals generated by the reader module 26. In a warehouse application, the secondary antenna 28 is configured to generate RF signals to activate RFID tags associated with shelves within the warehouse on which pallets or other objects are being placed or removed from (or to read RFID tags associated with shelves on which pallets have already been placed). RFID tag information from the activated RFID tags is then received by the secondary antenna 46 and processed as is known. It should be noted that the antenna pattern generated by the secondary antenna 46 is also a narrower pattern to encompass smaller areas, such as a single horizontal shelf in a multi-level shelf unit. The antenna pattern of the secondary antenna 46 may be generated in any known manner to activate RFID tags in a such a coverage area. For example, the narrower pattern allows a more focused RFID read that reduces or eliminates extraneous RFID read from adjacent pallets or shelves. Also, the antenna pattern of the secondary antenna 46 may be steerable as is known. The acquisition of RFID tag information from the shelves is discussed in more detail below.

It should be noted that in general the primary antenna 28 is configured to acquire RFID information from a first set of RFID tags (e.g., RFID item tags or RFID pallet tags) and the secondary antenna 46 is configured to acquire RFID information from a second set of RFID tags (e.g., RFID shelf tags or RFID floor tags). The first set of RFID tags and the second set of RFID tags are in proximity to one another, for example, within the same shelf unit, in the same physical area, etc. It should be noted that the first set of RFID tags and the second set of RFID tags may include only one RFID tag. Also, one or more optional antennas may be provided. For example, a floor tag antenna 27 may be provided and connected to the RFID reader 26 of the reader module 22. The floor tag antenna 27 is various embodiments is configured to acquire RFID information from a third set of RFID tags (or a subset of the first and second sets of RFID tags), such as floor tags (e.g., RFID tags on the floor)

It also should be noted that in some embodiments, the primary antenna 28 reads RFID tag information from both pallets and shelves (and floor tags) and the secondary antenna 46 reads RFID tag information from shelves (and floor tags). Any tags from pallets that are read by the secondary antenna 46 can be filtered. However, it should be appreciated that different filtering operations may be performed such as to filter some tags read by the primary antenna 28. Accordingly, the RFID shelf tag information read by the secondary antenna 46 may be used to identify the RFID pallet information read by the primary antenna 28.

The primary antenna 28 and secondary antenna 46 in the various embodiments are separate antenna structures. The primary antenna 28 and secondary antenna 46 are generally configured to activate and acquire RFID information from different RFID tags, for example, location specific RFID tags, such as RFID tags associated with pallets and shelves, respectively. In at least one embodiment, the primary antenna 28 and secondary antenna 46 are located in different positions or different orientations with respect to the RFID reader system 20. For example, in a warehouse application, the primary antenna 28 and secondary antenna 46 may be positioned or mounted at different locations of a forklift as described in more detail below.

Referring again to FIG. 1, the external antenna module 24 includes power supply or control components. For example, a first power regulator 48 (e.g., 3.3 volt power regulator) may be provided to power the motion sensor 40. A second power regulator 50 (e.g., a 5 volt power regulator) may be provide to power the pallet sensor 42, height sensor 44 and processor 38. Additional or different power regulators may be provided, for example, to provide different voltage outputs. The power regulators 48 and 50 receive input power from a power source of an object to which the RFID reader system 20 is connected, for example, the power supply of a forklift. The power supply or control components also may include a power conditioning component 52 that is configured, for example, to protect the power components, such as from noise from the power line and connection or disconnection of one or more of the components of the external antenna module 24 while the external antenna module 24 is powered on.

Thus, the RFID reader system 20 includes separate antennas 28 and 46 (an optionally floor tag antenna 27) that allow RFID information to be read from different RFID tags with the sensors 40, 42, 44 used to verify and/or confirm that the RFID information is valid. For example, the sensors 40, 42, 44 validate the specific pallet being moved and the location from which or to which the pallet was moved. Accordingly, in a warehouse application, the RFID reader system 20 is configured to separately read RFID tags associated with pallets and shelves and identify the specific pallet and location thereof As another example, the sensors 40, 42, 44 may be used to trigger RFID reads such that the reader system 20 is not constantly reading and verifying information.

In particular, the primary antenna 28 and secondary antenna 46 are configured to transmit a broad width antenna beam and a narrow width antenna beam, respectively. More specifically, the width of the transmitted antenna beam is wide for the primary antenna 46, for example, a horizontally wide beam to encompass a pallet. The width of the transmitted antenna beam is narrower for the secondary antenna 46, for example, a horizontally narrow bean to encompass, for example, a shelf. In a warehouse application, the primary and secondary antennas 28 and 46 are also positioned on a forklift such that the RFID reader 26 reads pallet RFID tags and shelf RFID tags, respectively. In some embodiments, the narrow and wide beams my be configured either horizontally or vertically narrow and wide, respectively. Additionally, the floor tag antenna 27 may be directed or pointed in a downward direction having either a narrow or wide beam to encompass one or more floor tags.

With respect to the sensors 40, 42, 44, different functions or operations are provided thereby, for example, for a mobile application. The motion sensor 40 (e.g., accelerometer) can, for example, determine whether or not the mobile reader system 20 is moving or stopped, as well as the direction of travel of the mobile reader system 20. The motion sensor 40 also can provide a location indication (and location tracking) for the mobile reader system 20 based on tracking of the acceleration in, for example, the x and y directions. The motion sensor 40 further can determine the velocity of the mobile reader system 20.

The motion sensor 40 can additionally determine a height of the mobile reader system 20. For example, the motion sensor 40 can be used to determine the height of a pallet that is being raised or has been raised by a forklift. This height information can be used to determine or verify (in combination with the shelf RFID tag) the shelf onto which the pallet is being placed or from which the pallet is being removed, for example, in a multi-level shelf unit. The motion sensor 40 also can identify (i) when a pallet has been picked up or (ii) when a pallet has been placed on a shelf or on the floor as these two events have distinct acceleration characteristics (signatures). The motion sensor 40 also me be used for tilt measurements of the fork gantry or assembly as described in more detail below;

The pallet sensor 42 (which optionally can be an infrared or other range sensor) can be directed in the same direction as one of the primary antenna 28 and the secondary antenna 46. In the configuration, the pallet sensor 42 can, for example, sense when a pallet is on a forklift or other vehicle moving the pallet. Additionally, the pallet sensor 42 can be used to determine whether the mobile reader system 20, and accordingly, the mobile vehicle to which the mobile reader system 20 is mounted or integrated, is approaching an object or moving away from an object (e.g., a pallet or shelf). This determination may be used to determine whether a pallet has been picked up or placed on the floor or on a shelf.

The height sensor 44 can be directed downward toward the floor such as on a moving portion oft for example, a forklift to determine the height of the moving portion and an pallet that may be on the moving portion, such as supported on the forks of a forklift. The height sensor 44 can thereby determine the height of a pallet, which may be used to determine or confirm on or from which shelf the pallet is being placed or removed. It should be noted that additional height information may be determined with the motion sensor 40 if, for example, required of as an auxiliary output.

It should be noted that the processor 38 can collect and associate the data from the sensors 40, 42, 44 and convert the data into, for example, one or more digital events for further processing by the RFID reader 26 (erg., to confirm the height of a pallet read from a shelf RFID tag). The processor 38 may, for example, convert analog signals from the sensors 40, 42, 44 to digital signals for further processing by the RFID reader 26. The RFID reader 26 also may communicate the digital event information to a network using the communications module 34. The data communicated over the network may be transmitted to the backhaul for integration into a control system or processor, for example, that tracks inventory within a warehouse. This information may be used, for example, to track the location of a forklift and when a pallet is moved onto or off of a shelf using the forklift. Optionally, WiFi signals from the communications module 34 may be used to determine the location of the RFID reader 26 using a Realtime location System (RTLS).

Thus, various embodiments of the invention provide a mobile reader system 20 for acquiring RFID information from RFID tags. Using focused antenna beams and different sensor types, for example, the sensors 40, 42, 44, RFID tag information may be acquired and confirmed such as in a warehouse environment. Moreover, improved location tracking is provided. Additional location information also can be integrated into the system by, for example, placing RFID tags on the floor of a warehouse at various locations. Thus, upon reading the RFID floor tags, a user may determine the location of the mobile reader system 20. Choke points also can be set up using this type of floor tag. Optionally, a gid of floor tags can be set up in a warehouse to determine vehicle location if desired or needed. These RFID floor tags provide location information as the mobile reader system 20 moves or drives by each tag and this information can be relayed, for example, to an enterprise system along with pallet and shelf RFID tag read information. Choke points also may be set up by placing RFID tags on doorways to determine the location of the mobile reader system 20 as the mobile reader system 20 passes through these doorways.

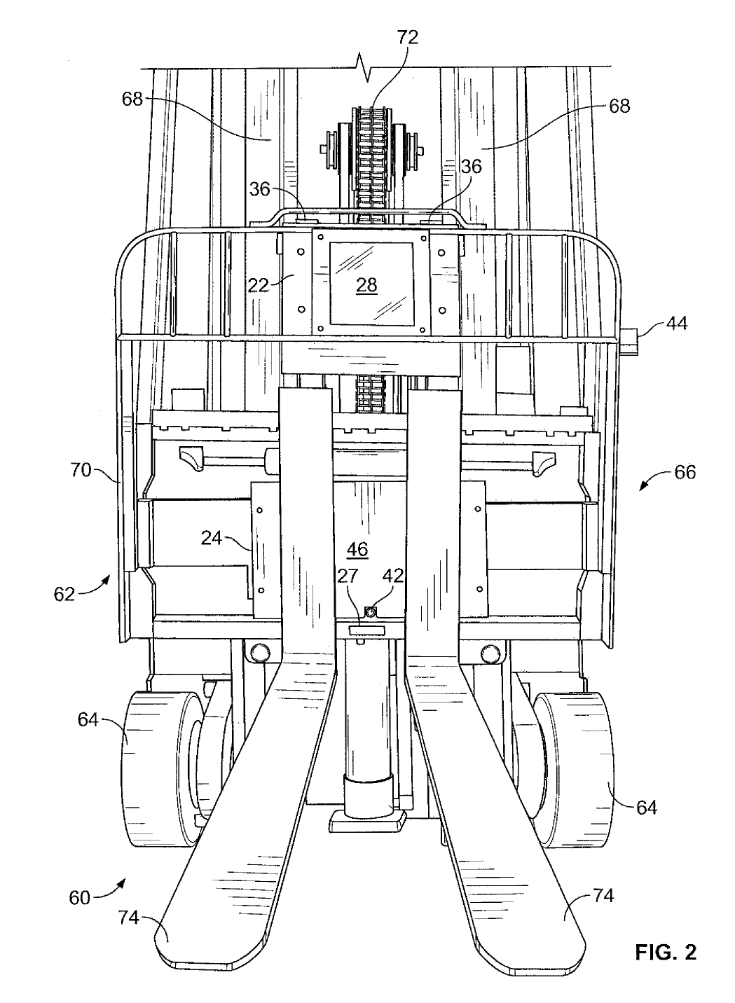

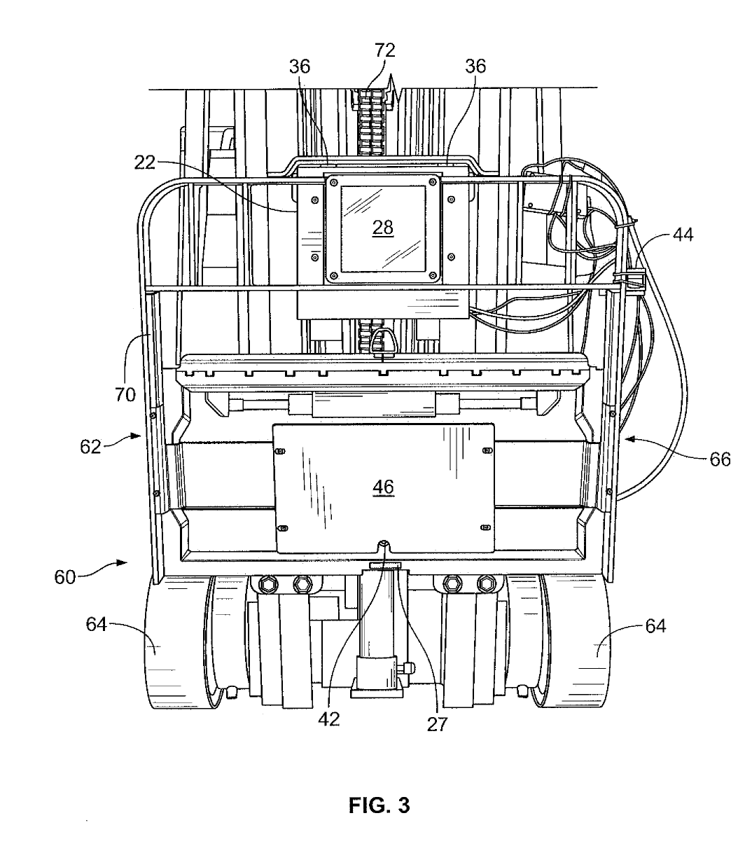

The mobile reader system 20 may be implemented in connection with any movable object or vehicle. In a warehouse application, the mobile reader system 20 may be implemented in connection with a forklift 60 as shown in FIGS. 2 and 3. The forklift 60 generally includes a body 62 supported on wheels 64 that moves the forklift 60 within the warehouse, for example, along the ground between shelving units. The forklift 60 includes a lifting assembly 66 that can be used, for example, to move and lift pallets. The lifting assembly 66 includes vertical guides or rails 68 along which a movable portion 70 can move vertically, which movement may be provided by one or more chains 72 or other mechanism linking the movable portion 70 to a motor (not shown). The movable portion 70 includes a fork assembly having one or more forks 74 (two forks 74 are shown) on which one or more pallets may be supported and raised or lowered to place or remove the one or more pallets on a shelf The forks 74 may include a generally horizontal portion for supporting the bottom of a pallet when lifted and a generally vertical portion for supporting a back portion of the pallet. Thus, the forks 74 engage an object, for example, a pallet to be moved, such as to be placed onto or removed from a shelf.

In the illustrated embodiment of the forklift 60, the primary antenna 28 is mounted at a top area of the movable portion 70 and the secondary antenna 46 is mounted at a bottom area of the movable portion 70 above or at the level of the forks 74. Optionally, the floor tag antenna 27 is mounted below the secondary antenna 46 (or may be provided as part of a single unit with the secondary antenna 46). However, other configurations and positioning of the primary antenna 28 and secondary antenna 46 are contemplated. In various embodiments, the primary antenna 28 is mounted vertically higher than the secondary antenna 46. However, the primary antenna 28 and the secondary antenna 46 may be mounted at the same height or the secondary antenna 46 may be mounted higher than the primary antenna 28. Additionally, the optional floor tag antenna 27 may be mounted above or below either or both of the primary antenna 28 and the secondary antenna 46. The primary antenna 28 and secondary antenna 46 are mounted on a back surface to the movable portion 70 to protect the primary antenna 28 and secondary antenna 46 from contact with an object being supported on the forks 74.

The pallet sensor 42 is mounted at about the same level (e.g., vertical height or same horizontal plane) as the forks 72 and may be integrated in the external antenna module 24 that also includes the secondary antenna 46. For example, the pallet sensor 42 may be positioned along a bottom middle portion of the external antenna module 24 at about the horizontal plane or slightly above the horizontal plane of the forks 74 such that the pallet sensor 42 is between the forks 74.

The height sensor 44 is also mounted on the movable portion 70, for example, on a side edge of the movable portion 70. The height sensor 44 may be mounted at any vertical height along the movable portion 70 with the height sensor 44 measurements offset such that a vertical height of zero is the condition when the forks 74 are on the ground or at the lowest position of the forks 74. The height sensor 44 may be mounted at any portion of the movable portion 70 so long as the height sensor 44 is pointed downward and has an unobstructed line of sight to the ground or a stationary reference point on the vehicle.

The communication antennas 36 may be provided along a top edge of the reader module 22 to facilitate communication with a wireless network within a warehouse. However, the communication antennas 36 may be placed or positioned at different locations as desired or needed. Additional or fewer communication antennas 36 may be provided.

It should be noted that component parts of the reader module 22 and external antenna module 24 not visible in FIGS. 2 and 3 may be within the housing of each of the reader module 22 and external antenna module 24 or may be mounted in other protective housing.

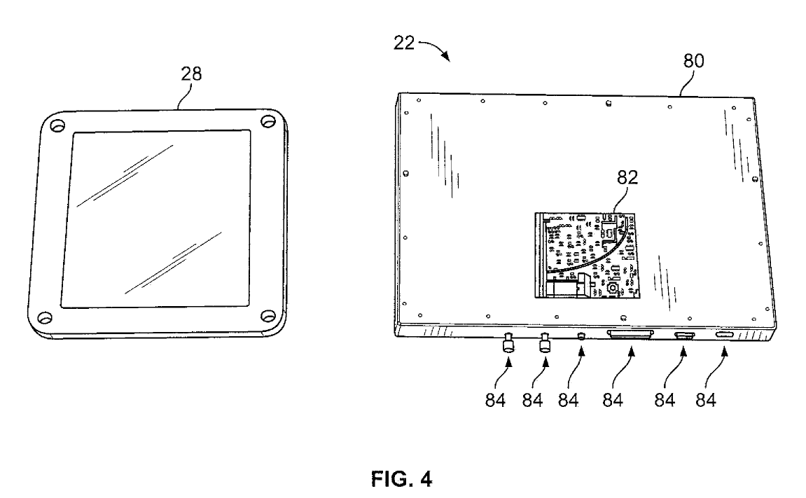

The reader module 22 may be constructed from a base portion 80 as shown in FIG. 4 and to which the primary antenna 26 is mounted. The base portion 80 may include an opening 82 to access the components within the reader module 22 and to allow connection of the primary antenna 28 to the base portion 80. When the primary antenna 28 is connected to the base portion 80, the opening 82 is covered. The base portion 80 also may include one or more connection ports 84 (e.g., RF port, coaxial port, serial port, parallel port, USB port, etc.) to allow connection of the reader module 22 to, for example, the external antenna module 24, a power supply (not shown), which may be the power supply of the forklift 60, etc.

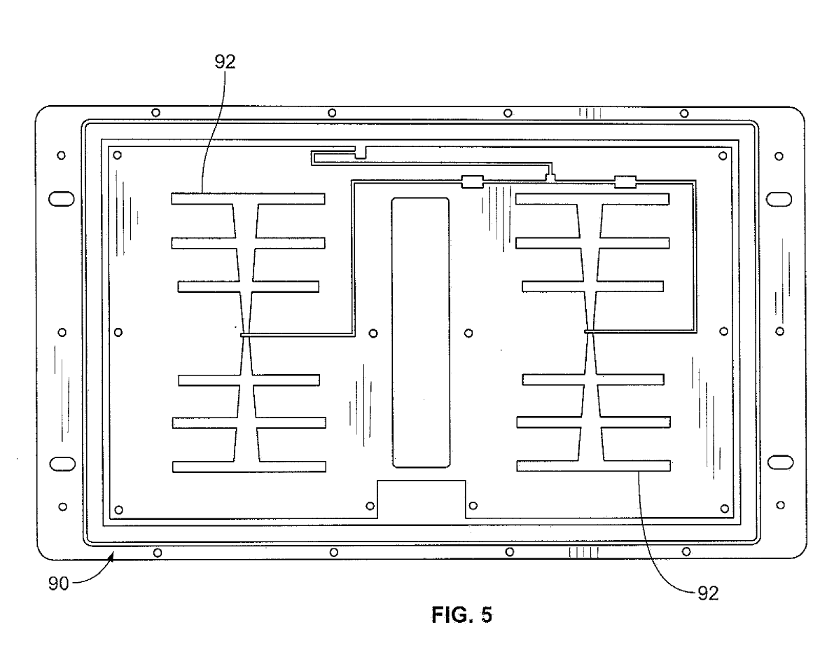

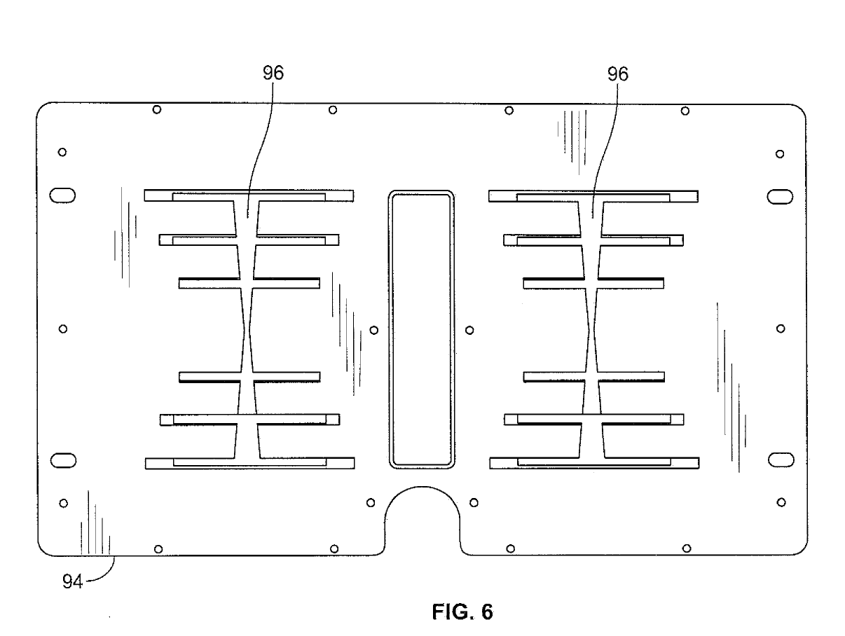

The primary antenna 28 and secondary antenna 46 are configured to transmit a broad width antenna beam and a narrow width antenna beam, respectively. For example, as shown in FIG. 5, the secondary antenna 46 may be formed from an antenna array 90 having two antenna elements 92. It should be noted that the primary antenna 28 may be formed in a similar manner. Each of the antenna elements 92 are formed from two opposing antenna structures, which may be formed as a printed antenna structure. The two antenna elements 92 are configured to provide phase cancellation as is known to generate narrow focused antenna beams. As should be appreciated, the shape and size of the antenna elements 92 may be modified to generate different antenna beam patterns of different widths, such as for different applications (e.g., a movable handcar application). For example, the antenna elements 92 may be configured in a “dog-bone” shaped design. A metal cover 94 as shown in FIG. 6 may include openings 96 having the same pattern as the antenna elements 92 and which is positioned over the antenna array 90. The openings 96 facilitate focusing of the antenna beams. It should be noted that the metal cover 94 may be formed from metal, for example, steel, such as a one-eighth inch thick piece of steel to provide additional reinforcement or ruggedness to the structure, for example, to make the structure more resistant when contacted or hit, such as by a pallet.

In particular, the secondary antenna beam is narrowed by using a multi-element array. In one embodiment a two element array is used, but additional elements may be utilized for applications where further narrowing of the beam pattern is required or desired. As an example, a slot antenna may be used in this multi-element antenna due to the inherent rugged construction for an industrial application. Slot antennas also allow for a smaller cavity behind the antenna element resulting in a lower profile design. Accordingly, a very low profile antenna that is very rugged and can withstand extreme abuse or use is provided.

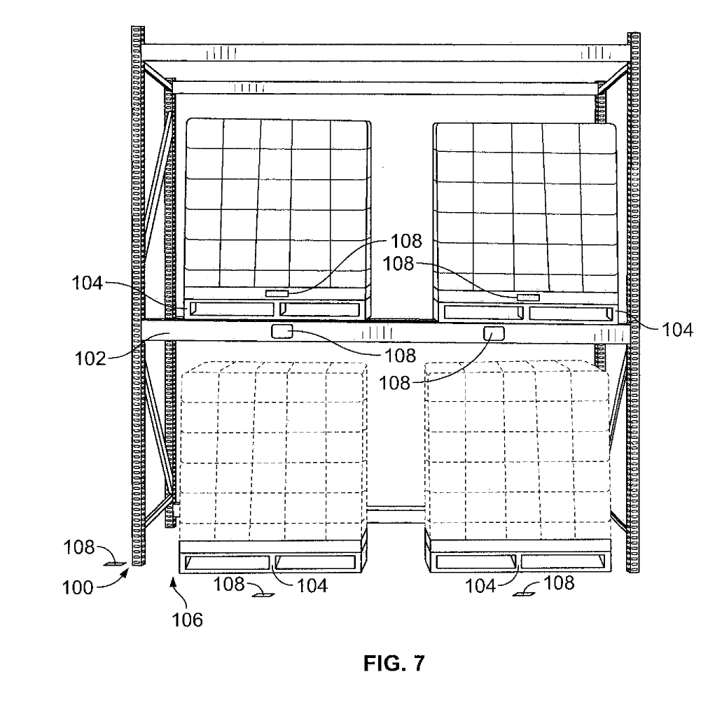

The antenna beams generated by the primary antenna 28 and secondary antenna 46 are focused to allow broad and narrow width RFID tag reading, respectively, such as in a warehouse setting. For example, as shown in FIG. 7, a shelf unit 100 may be a multi-level structure having one or more shelves 102 (one above the ground is shown). One or more pallets 104 may be stored on (e.g., supported on and maintained on) the shelves 102 or on a ground 106 below the shelves 102. It should be noted that a shelf 102 may be provided on the ground 106. Also, when used herein a pallet 104 generally refers to either (i) a support structure on which objects (e.g., products) may be supported and that is configured to be engaged, for example, by the forklift 60 such that the pallet may be moved or (ii) the entire structure with objects supported thereon. It should be noted that products in a pallet may be encased, for example, in shrink wrap or other covering. One or more shelf RFID tags 108, for example, passive RFID tags may be placed on each shelf 104, for example, on a front portion of the shelves 104. The shelf RFID tags 108 also may be placed on a side support of the shelf unit 100 at the level of the shelf 102 or may be placed on the ground 106 or floor (in front of the shelf 102 or to the side of the shelf 102).

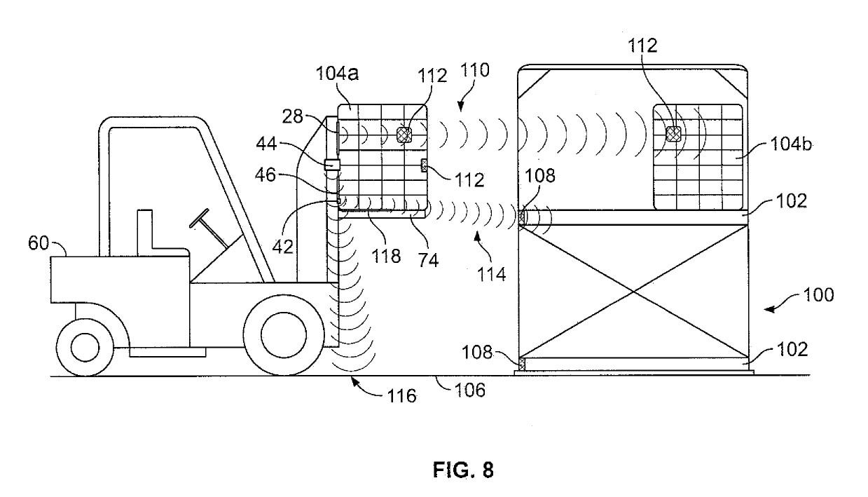

Thus, as shown in FIG. 8, as the forklift 60 approaches the shelf unit 100, the primary antenna 28 transmits an RF signal, for example, an RFID signal 110 that is directed such that one or more pallet RFID tags 112 (or item RFID tags) are activated and the RFID information stored therein acquired. It should be noted that the pallet RFID tags 112 may be located on a front, back, inside, etc. of the pallet 104. Also, it should be noted that the RFID signal 110 may activate, for example, pallet RFID tags 112 on (i) the pallet 104a that is being supported by the forks 74 and moved by the forklift 60 and/or (ii) the pallet 104b already on the shelf 102. However, the antenna beam from the primary antenna 28 may be directed such that none of the shelf RFID tags 108 are read nor pallet RFID tags 112 from pallets 104 on different shelves 102 or adjacent shelves 102 are read.

As the forklift 60 approaches the shelf unit 100, the secondary antenna 46 also transmits an RF signal, for example, an RFID signal 114 that is narrow and directed such that only shelf RFID tags 108 are activated and the RFID information stored therein acquired. However, because the antenna beam from the secondary antenna 46 is narrow, only the shelf RFID tags 108 at the level of the forks 74 are read.

The height sensor 44 also transmits a laser signal 116 downward toward the ground 106, for example, generally vertically downward. The laser signal 116 is then reflected upwards and used to determine a height of the forks 74. The pallet sensor 42 transmits an acoustic signal 118, for example, an acoustic wave at about the same horizontal plane of the forks 74. The acoustic signal 118 is reflected back off the pallet 104a (e.g., reflected back off of the shrink wrap encasing of the pallet 104a ) and is used to determine motion of the pallet 104a, such as when the pallet 104a is offloaded from the forks 74 or the pallet 104b is loaded onto the forks 74.

Thus, in various embodiments of the invention the mobile reader system 20 for reading RFID tags may be provided as part of a movable vehicle, such as the forklift 60. The mobile reader system 20 may receive threshold values, for example, pallet thresholds, fork height thresholds and vehicle stopped time thresholds from a controller, such as wirelessly from a remote main computer using the communications interface 34. The threshold values then may be provided to a sensor controller (not shown) that processes the raw sensor data from, for example, the sensors 40, 42, 44 based on the thresholds. The RFID reader 26 communicates the sensor information back to the remote controller to allow control of the activity or operation of the mobile reader system 20, such as the generation of RF signals from the primary antenna 28 and secondary antenna 46 or to determine the location of the forklift 60 (using the sensors and known starting location of the forklift 60 or last location based on an RFID that has been read) and, accordingly, the location of a pallet 104.

In various embodiments, the following states or thresholds may be used to control the operation of the mobile reader system 20 in a normal operation mode, such as when power is being supplied by the forklift 60 and the key to the forklift is in the on position:
1. Pallet On State—In this state the pallet sensor 42 detects pallets on the forks 74 that are within a preset threshold distance, for example, 24 inches from the pallet sensor 42. A “pallet on” indication is sent to the RFID reader 26 and is not reset until the pallet travels to a distance greater than the preset threshold distance from the pallet sensor 42.
2. Pallet Off State—In this state the pallet sensor 42 detects pallets that are at a distance greater than the preset threshold distance from the pallet sensor 42. A “pallet off” indication is sent to the RFID reader 26 and is not reset until the pallet travels to a distance within the preset threshold distance.
3. Vehicle Stopped State—In this state a signal is generated indicating that the forklift 60 is stopped. This signal may be generated by the microcontroller 38 based on a sensed condition of the motion sensor 40.
4. Vehicle Forward State—In this state a signal is generated indicating that the forklift 60 is moving in a forward direction. This information is communicated to the RFID reader 26, and if generated by the processor 38, communicated to a remote controller via a wireless network.
5. Vehicle Reverse State—In this state a signal is generated indicating that the forklift 60 is moving in a reverse direction. This information is communicated to the RFID reader 26, and if generated by the processor 38, communicated to a remote controller via a wireless network.
6. Fork Height Above Threshold—In this state a signal is generated based on a sensed height of the forks 74 by the height sensor 44 that the height of the forks 74 is above a preset threshold.
7. Fork Height Below Threshold—In this state a signal is generated based on a sensed height of the forks 74 by the height sensor 44 that the height of the forks 74 is below a preset threshold.
8. Zero Motion Threshold—In this state a signal is generated indicating the forklift 60 has been stopped for a period of time longer that a preset threshold value.

The above identified events are merely examples of one embodiment of the invention. Other events may be generated or used if required or desired for a specific use or application, such as based on the entity or enterprise using the system. It should be noted that the threshold values may be predetermined or preset based on a user input, a determined application, etc. Moreover, multiple threshold settings, for example, multiple fork height threshold settings or pallet on/off settings may be provided. Additional threshold settings also may be provided, such as fork height direction and pallet direction. It also should be noted that in a key off mode, which is identified when the key of the forklift 60 is placed in an off position, the mobile reader system 20 may switch to a battery backup and notify the remote controller of the condition. In this key off mode, the RF portion of the mobile reader system 20 may be turned off such that no RF signals are generated by the primary antenna 28 and secondary antenna 46. However, in this mode the wireless communication functionality, for example, the communications interface 34 may remain powered on for a predetermined period of time, for example, thirty minutes.

It should be noted that other conditions or faults may be identified and reported. For example, one or more faults from the sensors 40, 42, 44 may be provided, which results in an interrupt signal being sent to the RFID reader 26.

The control of transmission of information to and from the mobile reader system 20, including, for example, the RFID information, control signals (e.g., threshold values), etc. is provided by a controller, such as a remote or central server or computer that may communicate wirelessly with the mobile reader system 20. Also, depending on the configuration of the primary antenna 28 and secondary antenna 46, shelf RFID tags and/or pallet RFID tags may have to be placed in a predetermined location. For example, the shelf RFID tags may have to be placed in the center of shelves within a tolerance, for example, plus or minus four inches.

It should be noted that the components of the various embodiments may be protected for use in an industrial environment. For example, shock/isolation mounts may be used for mounting the antennas and sensors and crash bars or other structures may be provided to absorb impact of, for example, the forklift with an object, such as a shelf unit or a wall.

Thus, various embodiments of the invention provide a mobile RFID reader system that includes multiple antennas and different types of sensors. The multiple antennas provide accurate RFID tag reads and the sensors verify and confirm the RFID information read from the RFID tags. The mobile RFID reader reduces or eliminates the need for operator intervention, increases read rate accuracy and reduces or eliminates the issue of multiple RFID shelf tag reads or erroneous reads. Thus, high levels of confidence and accuracy of RFID information and the location from where the RFID information was acquired, for example, in a warehouse environment are provided.

The various embodiments or components, for example, the RFID reader system and components therein or controllers thereof may be implemented as part of one or more computer systems, which may be separate from or integrated with other systems. The computer system may include a computer, an input device, a display unit and an interface, for example, for accessing the Internet. The computer may include a microprocessor. The microprocessor may be connected to a communication bus. The computer may also include a memory. The memory may include Random Access Memory (RAM) and Read Only Memory (ROM). The computer system further may include a storage device, which may be a hard disk drive or a removable storage drive such as a floppy disk drive, optical disk drive, and the like. The storage device may also be other similar means for loading computer programs or other instructions into the computer system.

As used herein, the term “computer” may include any processor-based or microprocessor-based system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer system executes a set of instructions that are stored in one or more storage elements, in order to process input data. The storage elements may also store data or other information as desired or needed. The storage element may be in the form of an information source or a physical memory element within the processing machine.

The set of instructions may include various commands that instruct the computer as a processing machine to perform specific operations such as the methods and processes of the various embodiments of the invention. The set of instructions may be in the form of a software program. The software may be in various forms such as system software or application software. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM SNVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. For example, the ordering of steps recited in a method need not be performed in a particular order unless explicitly stated or implicitly required (e.g., one step requires the results or a product of a previous step to be available). While the dimensions and types of materials described herein are intended to define the parameters of the invention, they are by no means limiting and are exemplary embodiments. Many other embodiments will be apparent to those of skill in the art upon reviewing and understanding the above description. The scope of the invention should, therefore, be determined with reference to the appended claims, along with the fill scope of equivalents to which such claims are entitled. In the appended claims, the terms “including” and “in which” are used as the plain-English equivalents of the respective terms “comprising” and “wherein.” Moreover, in the following claims, the terms “first,” “second,l” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A radio frequency identification (RFID) reader system comprising:
an RFID reader;
a primary antenna for transmitting RFID signals to acquire RFID information from RFID item tags; and
a secondary antenna for transmitting RFID signals to acquire RFID information from one of RFID shelf tags and RFID floor tags.

2. An RFID reader system in accordance with claim 1 wherein pallets with which the RFID item tags are associated are movable with respect to shelves with which the RFID shelf tags are associated.

3. An RFID reader system in accordance with claim 1 wherein the RFID reader comprises a portable RFID reader.

4. An RFID reader system in accordance with claim 1 wherein the primary antenna comprises a broad beam antenna configured to transmit a broad RFID signal beam and the secondary antenna comprises a focused antenna configured to transmit a narrow RFID signal beam.

5. An RFID reader system in accordance with claim 1 further comprising a communications interface configured to provide wireless communications with the RFID reader.

6. An RFID reader system in accordance with claim 1 further comprising a plurality of different sensors configured to validate RFID reads by the RFID reader.

7. An RFID reader system in accordance with claim 1 further comprising an accelerometer providing one of movement and location information for the RFID reader.

8. An RFID reader system in accordance with claim 1 further comprising a height sensor providing height information for one of the primary antenna and secondary antenna.

9. An RFID reader system in accordance with claim 1 further comprising a pallet sensor providing movement information for a pallet to which at least one of the RFID item tags is associated.

10. An RFID reader system in accordance with claim 1 wherein the primary antenna and the secondary antenna transmit RFID signal beams at different vertical heights.

11. An RFID reader system in accordance with claim 1 further comprising a movable member and wherein the primary antenna and secondary antenna are both positioned on the movable member.

12. An RFID reader system in accordance with claim 1 further comprising a slotted multi-element secondary antenna having a low profile and narrow beam width.

13. A forklift comprising:
a movable portion having at least one fork;
a radio frequency identification (RFID) reader;
a primary antenna mounted to the movable portion; and
a secondary antenna mounted to the movable portion, the primary and secondary antennas transmitting RFID signals for reading RFID tags by the RFID reader.

14. A forklift in accordance with claim 13 wherein the primary antenna is mounted vertically higher than the secondary antenna.

15. A forklift in accordance with claim 13 wherein the primary antenna is mounted at a top of the movable portion and the secondary antenna is mounted at a bottom of the movable portion.

16. A forklift in accordance with claim 13 wherein the secondary antenna is mounted at a same vertical height as the at least one fork.

17. A forklift in accordance with claim 13 wherein the primary antenna is configured to transmit RFID signals to read RFID tags on pallets and the secondary antenna is configured to transmit RFID signals to read RFID tags on shelves.

18. A forklift in accordance with claim 13 further comprising a plurality of different types of sensors to validate information read from the RFID tags.

19. A forklift in accordance with claim 13 further comprising an accelerometer to determine one of movement and location of the RFID reader.

20. A forklift in accordance with claim 13 further comprising a pallet sensor mounted at about a same vertical height as the at least one fork and configured to sense movement of a pallet on the at least one fork.

21. A forklift in accordance with claim 13 farther comprising a height sensor mounted to the movable member and configured to determine a height of the at least one fork.

22. A method for tracking inventory, the method comprising:
transmitting an RFID signal from a first antenna mounted to a forklift;
transmitting an RFID signal from a second antenna mounted to a forklift; and
validating RFID information received in response to at least one of the RFID signals transmitted from the first antenna and the second antenna, the RFID information validated using information from a plurality of different sensor types.
